(19) United States
(12) Patent Application Publication
(10) Pub. No.: US 2013/0191151 A1
(43) Pub. Date: Jul. 25, 2013

(54) ADDING PROBLEM ENTRIES TO A PATIENT SUMMARY

(71) Applicants: Lee M. SURPRENANT, Cary, NC (US); Jacob D. EISINGER, Austin, TX (US); Richard M. ROGERS, Raleigh, NC (US)

(72) Inventors: Lee M. SURPRENANT, Cary, NC (US); Jacob D. EISINGER, Austin, TX (US); Richard M. ROGERS, Raleigh, NC (US)

(73) Assignee: INTERNATIONAL BUSINESS MACHINES CORPORATION, Armonk, NY (US)

(21) Appl. No.: 13/406,323

(22) Filed: Feb. 27, 2012

Related U.S. Application Data
(63) Continuation of application No. 13/355,041, filed on Jan. 20, 2012.

(51) Int. Cl. G06Q 50/24

(52) U.S. Cl. 705/3

(57) ABSTRACT

Information including a data set indicative of a condition is categorized by changing a categorization state of the data from an active state to a past state based on a time of an update (e.g., time of an update of a diagnosis, when a file may be updated) indicative of a resolution of the condition. When a most recent entry in the data set exceeds a duration range for the condition as determined by a knowledge base, the categorization state of the data is changed from the active state to the past state. Further, it is determining whether the condition is correlated with a treatment. When the correlated treatment is being taken by a subject, changing the categorization state of the data from the active state to the past state.

### CROSS-REFERENCE TO RELATED APPLICATION

This is a Continuation Application of U.S. application Ser. No. 13/355,041, filed Jan. 20, 2012, in the U.S. Patent and Trademark Office, the disclosure of which are incorporated herein by reference in its entirety.

### BACKGROUND

1. Field

[02] Aspects of the example embodiments are directed to record management, and more specifically, to a method and non-transitory article of manufacture of categorizing active and past medical information for correlation with a treatment.

2. Related Art

Patient medical history has a tendency to include repeating events. For example, medical ailments may appear to be cured or resolved, but may then return thereafter. For example but not by way of limitation, allergies may be considered a repeating medical event.

Accordingly, a related art health record summary is generated by including previous bits of information related to the patient medical information. This health record summary including the patient medical information can be digitized and shared across organizations by medical professionals, and applied for diagnosis and treatment of patients that encounter different organizations (e.g., healthcare providers).

A related art model for packaging and sharing patient data is via a shared or federated document repository, populated by healthcare organizations with standardized documents representing patient data from a given encounter. Healthcare organizations may be required to do this as a component of their demonstration of meaningful use of electronic medical record systems.

There is a related art need to determine which subset or subsets of the digitized and shared patient medical information to share. More specifically, there is a related art need to determine which information from a potentially large set of medical records for a given patient must be shared to create a patient's medical summary.

Related art medical history record management includes diagnosis and treatment of problem concerns. Problems or concerns can be expressed through a series of observations ranging from patient complaint to symptoms to diagnoses (e.g., symptom=cough, finding=rusty-colored sputum, diagnosis=pneumonia).

Related art Electronic Health Record (EHR) systems divide these problem concerns into Active Problems and Past Problems.

Such related art EHR systems require inclusion of active problems due to their high importance in all patient summaries. Inclusion of past problems is also of high importance, particularly with respect to chronic conditions in remission, or possible relevant information for future treatment. However, in the related art, there is an unmet need to determine, from a given set of medical records, the patient's active problems and the records of relevance for those active problems.

### BRIEF SUMMARY

Aspects of the exemplary embodiments relate to a method of categorizing information including a data set indicative of a condition. The method comprises changing a categorization state of the data from an active state to a past state based on a time of an update (e.g., time of an update of a diagnosis, when a file may be updated) indicative of a resolution of the condition, when a most recent entry in the data set exceeds a duration range for the condition as determined by a knowledge base, changing the categorization state of the data from the active state to the past state, and determining whether the condition is correlated with a treatment, and when the correlated treatment is being taken by a subject, changing the categorization state of the data from the active state to the past state.

Additional aspects of the exemplary embodiments relate to a non-transitory computer readable medium configured to store instructions for categorizing information including a data set indicative of a condition. The instructions include changing a categorization state of the data from an active state to a past state based on a time (e.g., time of an update of a diagnosis, when a file may be updated) indicative of a resolution of the condition, when a most recent entry in the data set exceeds a duration range for the condition as determined by a knowledge base, changing the categorization state of the data from the active state to the past state, and determining whether the condition is correlated with a treatment, and when the correlated treatment is being taken by a subject, changing the categorization state of the data from the active state to the past state.

Further aspects of the exemplary embodiments relate to an apparatus for categorizing information including a data set indicative of a condition, the apparatus including a processor and a memory. The apparatus includes a changing unit that changes a categorization state of the data from an active state to a past state based on a time of an update (e.g., time of an update of a diagnosis, when a file may be updated) indicative of a resolution of the condition, and when a most recent entry in the data set exceeds a duration range for the condition as determined by a knowledge base, changes the categorization state of the data from the active state to the past state. The apparatus also includes a determining unit that determining whether the condition is correlated with a treatment, and when the correlated treatment is being taken by a subject, changes the categorization state of the data from the active state to the past state.

It is to be understood that both the foregoing and the following descriptions are exemplary and explanatory only and are not intended to limit the claimed embodiments or application thereof in any manner whatsoever.

### BRIEF DESCRIPTION OF THE SEVERAL VIEWS OF THE DRAWINGS

The accompanying drawings, which are incorporated in and constitute a part of this specification exemplify the exemplary embodiments and, together with the description, serve to explain and illustrate principles of the inventive techniques. More specifically:

FIG. 1 illustrates a first exemplary process, related to grouping of concern entries;

FIG. 2 illustrates a second exemplary process related to active concern entries;

FIG. 3 illustrates a second exemplary process related to active concern entries; and

FIG. 4 illustrates an exemplary block diagram of a computer/server system upon which an exemplary embodiment may be implemented.

### DETAILED DESCRIPTION

In the following detailed description, reference will be made to the accompanying drawings, in which identical functional elements are designated with like numerals. The aforementioned accompanying drawings show by way of illustration, and not by way of limitation, specific embodiments and implementations. These implementations are described in sufficient detail to enable those skilled in the art to practice the exemplary embodiments and it is to be understood that other implementations may be utilized and that structural changes and/or substitutions of various elements may be made without departing from the scope and spirit of exemplary embodiments. The following detailed description is, therefore, not to be construed in a limited sense. Additionally, the exemplary embodiments as described may be implemented in the form of software running on a general purpose computer, in the form of a specialized hardware, or combination of software and hardware.

The example embodiments are directed to determining, from a collection of documents, a list of active and past problems that should be considered by a clinician when treating a patient. Relevant problem data is captured and analyzed with respect to external data sources, to provide guidance for a clinician with respect to the contents of the list of active and past problems. Accordingly, accurate, current and relevant data with respect to a patient condition (e.g., problem) can thus be provided in a manner that gives a clinician a single view. For example, but not by way of limitation, an accurate active problem list provides clinical decision support.

More specifically, example embodiments include aggregated problem data from relevant documents, and incorporate additional metadata (e.g., flags), so that a clinician can quickly review and comprehend relevant active problem data for a patient encounter.

In the example embodiments, medical documents or other patient history with structured or unstructured records (e.g., problem entries) are provided. One or more related art ‘terminology’ sets that are well-known in the art may be used for the problem entries, such as SNOMED CT (Systemized Nomenclature of Medicine—Clinical Terms), or ICD-9 or ICD-10 (International Classification of Diseases). For example, but not by way of limitation, SNOMED CT is an ontology that classifies clinical terms into groups.

However, the foregoing sets are intended to be exemplary in nature. One of ordinary skill in the art would understand that another coding system, or no coding system at all, could be substituted therefor without departing from the scope of the inventive concept.

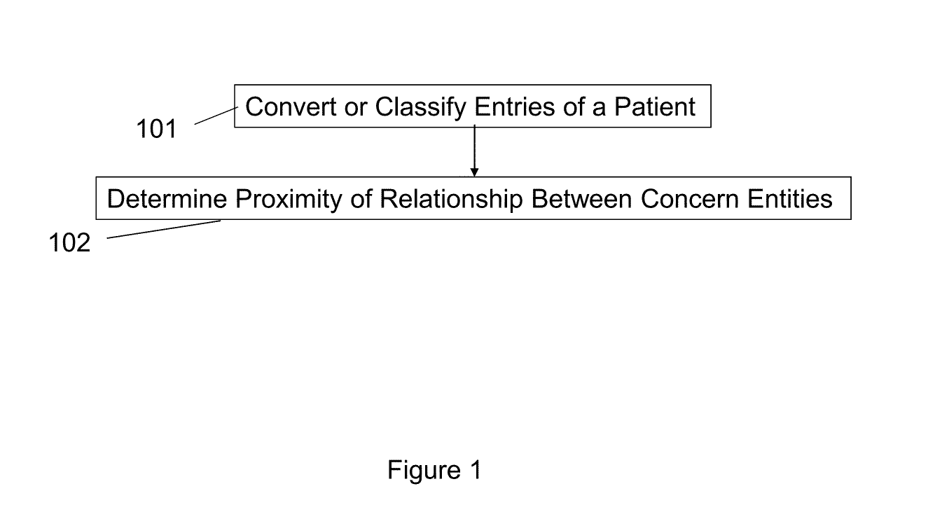

FIG. 1 illustrates an exemplary process. In 101, concern entries of a patient may be converted or classified via one of the above-noted terminology sets (e.g., SNOMED CT. In 102, a determination is made as to the proximity of relationship between the concern entries, and whether concern entries can be grouped or into a problem concern.

The foregoing exemplary process can be implemented by use of ontological tools that operate over the SNOMED knowledge base. For example, but not by way of limitation, direct relationships (e.g., synonym, is-a, has-a, etc.) relationships may be employed. Alternatively, ‘proximitry’ on the hierarchical knowledge base (e.g., both concern entries extend from a common high-level disease classification) may also be employed. The foregoing exemplary process may be configured based on the configuration of the system, or the specific conditions provided for the given instance of the summarization request

The exemplary process as explained above and illustrated in FIG. 1 provides a proximity of the relationship between concern entries, as well as a determination with respect to possible common grouping of the concern entries.

As disclosed above with respect to the related art, problem concerns can be grouped into active problem concerns and passive problem concerns. The exemplary embodiments incorporate additional metadata (e.g., flags) into the active problem concerns and past problem concerns.

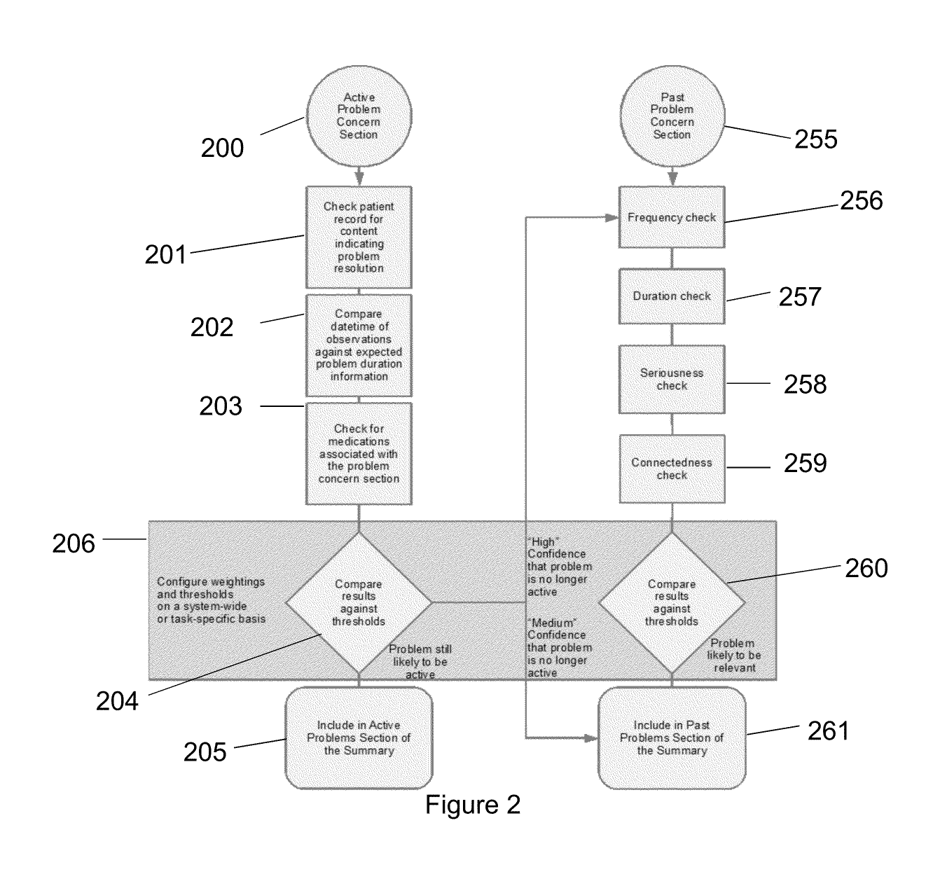

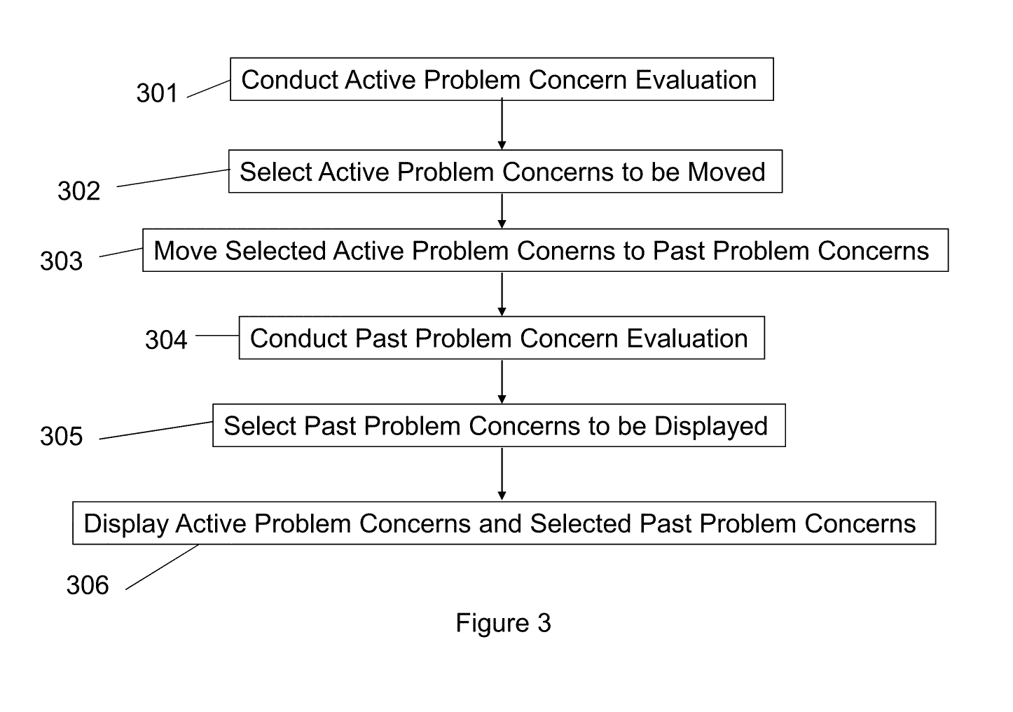

FIG. 2 illustrates an exemplary process. An active problem concern section 200 and a past problem concern section 255 are provided. The active problem concern section 200 is for incorporating metadata into the active problem concerns. The exemplary process of FIG. 3 is performed for each active problem concern group in a patient's history.

In 201, a search of the patient record is performed to determine whether content exists that provides an indication that the problem has been resolved. For example, but not by way of limitation, a search of the data is performed for clinical statements that indicate the condition is no longer active, or later documents that demonstrate movement of that the concern from the active group to the past group.

According to one exemplary embodiment of 201, when a timestamp of an indication a resolution is later than a timestamp that is indicative of the latest problem entry in the group, the problem concern is characterized as having been resolved, and thus moved from the active group to the past group that includes a list of past problems to consider for inclusion. Treatment of the past problem group is discussed in greater detail further below.

Additionally, the exemplary embodiment of FIG. 2 may also incorporate an account confidence level with respect to the determination that the problem concern is no longer considered active. The confidence level may be generated by a health care professional (e.g., clinician) who assesses the situation and enters the confidence level. For example, a chronic problem (e.g., diabetes patient not taking a certain type of insulin, possibly due to a replacement drug on the market) or a recurring problem have a difference confidence level than other problems.

In 202, a clinical knowledge base is referenced with respect to a datestamp (i.e., datetime) to determine an indicator as to whether the maximum reasonable duration of the given condition has been passed (i.e., problem duration information). For example, the clinical knowledge base may include (but is not limited to) an internal or external knowledge base such as a national disease registry. For chronic conditions, such knowledge bases would characterize the expected duration as spanning the lifetime of the patient. Accordingly, such chronic conditions are included in the active problems section, and may not be moved to the past problems grouping.

When it is determined that a most recent problem entry of this problem concern section is not within the duration range, of the condition, the problem concern is moved into the list of past problem group. Treatment of the past problem group is discussed in greater detail further below.

In 203, medication records are queried to determine the existence of medications that are associated with the problem concern. Such medication records may be found in the same documents as the problem entries. The medications (e.g., prescriptions) may be repeating or current. Such medication information may be kept up-to-date more frequently than problem lists. A reason for the difference in the frequency of update includes potential drug-to-drug interactions, and the necessity for patients to order refills for controlled substances.

Where no explicit linkage is demonstrated between the medication and the problem, a correlation may be inferred. The inferred linkage is indicated by confidence levels and evidence. Such an inference may optionally be generated by co-location and/or external clinical knowledge.

Additionally, in 203, a determination may be made as to whether a patient continues to take the medication that most closely corresponds to the problem concern that is being evaluated. If the patient does not continue to take the medication corresponding to the problem concern, an indication may be provided that the problem concern is “possibly resolved”. However, the problem concern continues to be maintained in the active problems grouping.

Once the foregoing evaluations have been performed, determinations are made as shown in 206 to change a problem concern from active to past, and to determine a confidence level of the problem concern status. Based on these determinations in 206, the problem concern may be displayed in the summary at the Active Problems section (205) or the Past Problems section (261), or not displayed at all. Further details of 206 are disclosed as follows.

As shown in 204, the results of 201, 202 and 203 are compared against thresholds. This may be done on a systematic level, or on a task-by-task level. Based on the comparison, it is determined whether the problem concern is likely to be active. If so, the problem concern is maintained in the active problem concern section at 205.

If it is determined that the problem concern is not likely to be active, a determination is made regarding the confidence level, as explained above. The confidence level is determined at or above a threshold, (e.g., “high” confidence that a problem is no longer active) or below the threshold (e.g., “medium” confidence that a problem is no longer active).

If the confidence level is “medium”, the past problem concern is listed in a “past problems” section of the summary as shown in 261. If the confidence level is “high”, the past problem concern section 300 performs processing as explained below.

Accordingly, metadata of the active problem concerns based on the exemplary process as explained above and illustrated in the active problem concern section 200. Thus, the active history information can be processed, and entries moved or flagged as necessary, to provide further decision support (e.g., accurate, current and relevant) for the clinician.

The foregoing method includes exemplary metadata that may be analyzed to determine whether a problem concern is active or past. However, other metadata may be substituted therefor, and/or or added thereto, without departing from the scope of the inventive concept.

The past problem concern section 255 incorporates the metadata into the past problem concerns. For example, but not by way of limitation, the past problem concerns are weighed with one or more algorithms. The purpose of the weighting is to determine which past problem concerns (if any) should be included in a summary. Below a weighting threshold, a past problem concern may not be included in the summary. Moreover, a separate view of past problem concerns may be included in the summary section.

In 256, each past problem concern in the past problem group is weighted based on frequency of problem concern entries in the past problem group. For example, but not by way of limitation, this may include a number of times that the patient suffered from this problem concern, and/or how many times the patient was treated for the problem concern.

In 257, each past problem concern in the group is weighted based on duration. For example but not by way of limitation, an amount of time spent by the patient spent dealing with the given problem concern is used to weight the past problem concerns.

In 258, each past problem concern is weighted based on severity and/or seriousness. For example, but not by way of limitation, this may be weighted as follows:
High: Life threatening or potential to cause permanent injury
Moderate: Noticeable adverse consequences but unlikely to threaten life or cause permanent injury
Low: Potential adverse consequences but unlikely to substantially affect subject's situation/quality of life.

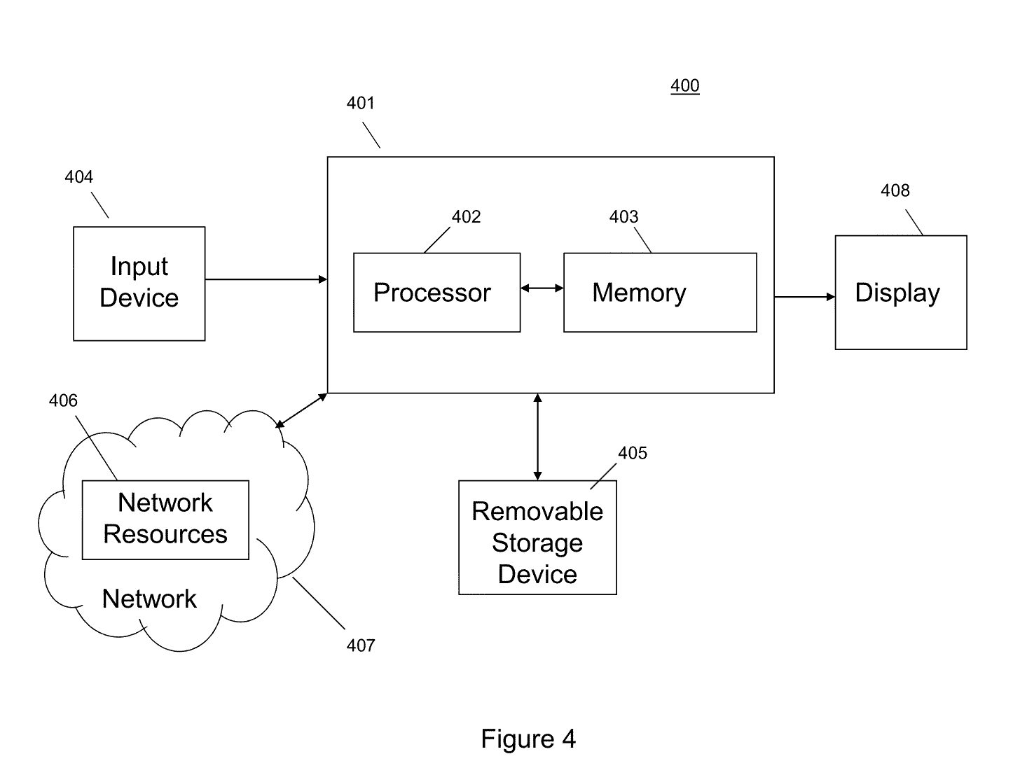

In 259, connectedness may be weighed. For example but not by way of limitation, the importance of a problem concern may correlate to a number of times it is referenced across the entire set of medical summaries. A related art search algorithm as illustrated in FIG. 4 may be used.

As shown in 260, the foregoing checks at 256, 257, 258, 259 are compared against thresholds at 260. If it is determined that the problem is likely to be relevant (e.g., above a weighted threshold), the past problem concern is included in the summary at the Past Problems Section as shown in 261.

Accordingly, in view of the foregoing exemplary process as explained above, the past history information can be weighted to provide further decision support (e.g., accurate, current and relevant) for the clinician. While several parameters are illustrated in FIG. 2 as being analyzed and weighted, other parameters may be substituted therefor and/or added thereto, as would be understood by one skilled in the art, without departing from the scope of the inventive concept.

FIG. 3 illustrates another exemplary process. In 301, active problem concerns are evaluated. For example, but not by way of limitation, the active problem concerns may be evaluated against a set of medical parameters. The set of medical parameters may include, but is not limited to, medications, duration of condition, and patient data. Depending on processing and/or storage capacity requirements, the number of parameters may be adjusted upward or downward. Moreover, the clinician may selectively choose parameters, depending on the their subjective judgment of the situation. The evaluation of the medical parameters thus generates an evaluation result for each of the parameters.

In 302, the evaluation results for each of the parameters indicative of a problem concerns are used to determine whether to move a problem concern from an active state to a past state. This selection can be based on a criteria that is determined based on a well-known record (e.g., maximum duration of a problem concern has passed, and thus the problem concern is moved to the past problem concern category). In 303, the problem concerns that are determined to not be active problem concerns are moved to past problem concerns. Optionally, a clinician may attach a degree of confidence to the determination for the moved active problems. For example, a clinician may attach a lower degree of confidence for a medication which the user has not taken, if the user has a history of not taking medication that has been prescribed, particularly with respect to a chronic condition.

In 304, the past problem concerns, including those that were moved in 303, are evaluated. For example, the past problem concerns may be weighted or otherwise scored or ranked with respect to their characteristics, such as (but not limited to) frequency, duration, seriousness, or connectedness.

In 305, a determination is made as which of the past problem concerns are to be displayed. The past problem concerns to be displayed may include those conditions having a higher ranking or weighting, i.e., those that would be more relevant to the clinician.

In 306, the active problem concerns are displayed in a first portion of a summary screen, and the selected past problem concerns are displayed in a second portion of the summary screen. Thus, all of the active problem concerns that were not moved to past problem concerns, as well as the past problem concerns that have been selected, are displayed.

While the foregoing exemplary embodiments disclose healthcare record management, the present inventive concept is not limited thereto. For example, the inventive concept may be applied to fields other than healthcare record management, as would be understood by those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

FIG. 4 is a block diagram that illustrates an embodiment of a computer/server system 400 upon which an exemplary embodiment may be implemented. The system 400 includes a computer/server platform 401 including a processor 402 and memory 403 which operate to execute instructions, as known to one of skill in the art. The term “computer-readable medium” as used herein refers to any medium that participates in providing instructions to processor 502 for execution. Modules or software units described throughout the specification may also be executed by the processor 402. Additionally, the computer platform 401 receives input from a plurality of input devices 404, such as a keyboard, mouse, touch device or verbal command.

The computer platform 401 may additionally be connected to a removable storage device 405, such as a portable hard drive, optical media (CD or DVD), disk media or any other medium from which a computer can read executable code. The computer platform may further be connected to network resources 406 which connect to the Internet or other components of a local public or private network. The network resources 406 may provide instructions and data to the computer platform from a remote location on a network 407. The connections to the network resources 406 may be via wireless protocols, such as e.g., the 802.11 standards or cellular protocols, or via physical transmission media, such as cables or fiber optics. The network resources may include storage devices for storing data and executable instructions at a location separate from the computer platform 401. The computer interacts with a display 408 to output data and other information to a user, as well as to request additional instructions and input from the user. The display 408 may therefore further act as an input device 404 for interacting with a user.

For example, but not by way of limitation, the computer platform 401 may include a changing unit and a determination unit. The changing unit changes a categorization state of the data from an active state to a past state based on a time of an update (e.g., time of an update of a diagnosis, when a file may be updated) indicative of a resolution of the condition, and when a most recent entry in the data set exceeds a duration range for the condition as determined by a knowledge base, changes the categorization state of the data from the active state to the past state. The determining unit determines whether the condition is correlated with a treatment, and when the correlated treatment is being taken by a subject, changes the categorization state of the data from the active state to the past state.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method of categorizing information including a data set indicative of a condition, the method comprising:
changing a categorization state of the data from an active state to a past state based on a time of an update indicative of a resolution of the condition;
when a most recent entry in the data set exceeds a duration range for the condition as determined by a knowledge base, changing the categorization state of the data from the active state to the past state; and
determining whether the condition is correlated with a treatment, and when the correlated treatment is being taken by a subject, changing the categorization state of the data from the active state to the past state.

2. The method of claim 1, wherein the information comprises medical information the subject comprises a patient, and the treatment comprises a medication, and the condition comprises a medical condition associated with the patient.

3. The method of claim 1, further comprising applying a confidence interval prior to the changing of the categorization state of the data from the active state to the past state.

4. The method of claim 1, further comprising, for the condition having the past state as the categorization state, determining a relevance of the condition by performing weighting based on at least one of frequency, duration, severity, and connectedness to another condition.

5. The method of claim 4, further comprising, for the condition having the past state for which the relevance is determined to be greater than a threshold level, displaying the data in a past condition display.

6. The method of claim 1, further comprising, for the condition having the active state as the categorization state, displaying the data in an active condition display.
